(19) United States
(12) Patent Application Publication
(10) Pub. No.: US 2014/0215806 A1
(43) Pub. Date: Aug. 7, 2014

(54) STATOR MANUFACTURING METHOD AND STATOR MANUFACTURING APPARATUS

(71) Applicant: AISIN AW CO., LTD., Anjo-shi, Aichi-ken (JP)

(72) Inventors: Yasuo Yamaguchi, Kariya (JP); Yoshio Kato, Inazawa-shi (JP)

(21) Appl. No.: 14/239,951

(22) PCT Filed: Sep. 28, 2012
(86) PCT No.: PCT/JP2012/075032

§ 371 Date: Feb. 20, 2014

(30) Foreign Application Priority Data
Oct. 4, 2011 (JP) 2011-220363

(51) Int. Cl. H02K 15/06; H02K 3/48

(52) U.S. Cl. CPC H02K 15/065; H02K 3/48
USPC 29/596; 29/736

(57) ABSTRACT

A stator manufacturing method involving a coil arrangement process, a coil deformation process, and a coil insertion process. During the coil arrangement process, a plurality of annular conductors constituting the coil are disposed in a coil holder such that a first portion of each of the annular conductors is inserted into a first catching gap formed between the blades, a second portion of each of the annular conductors is inserted into a second catching gap that is away from the first catching gap by a predetermined pitch. During the coil deformation process the coupling portion of each of the plurality of annular conductors is deformed by moving the coil pusher in the axial direction along the blades. During the coil insertion process the first and second portion of each of the annular conductors are inserted into the slots by further moving the coil pusher in the axial direction.

### TECHNICAL FIELD

The present invention relates to a stator manufacturing method for manufacturing a stator by winding a coil around a stator core, and to a stator manufacturing apparatus for manufacturing the stator.

### BACKGROUND ART

As one method for manufacturing a stator by winding a coil around a stator core, there is known a method in which a plurality of annular conductors formed in an annular shape are inserted into slots of a stator core by a coil insertion device as described in Japanese Patent Application Publication No. 2009-5434 (JP 2009-5434 A) (Patent Document 1), for example. Use of the coil insertion device facilitates insertion of the annular conductors into the slots of the stator core. In Patent Document 1, a plurality of crossover portions of coil end portions of the coil of the manufactured stator that project in the axial direction from the stator core are disposed concentrically as viewed in the axial direction.

Meanwhile, there is also known a stator in which a plurality of crossover portions of coil end portions that project in the axial direction from a stator core are disposed in a spiral shape as viewed in the axial direction as described in Japanese Patent Application Publication No. 2007-336720 (JP 2007-336720 A) (Patent Document 2), for example. In the stator, each of the crossover portions is disposed such that one end portion of the crossover portion in the circumferential direction is positioned radially inwardly of the other crossover portions located at the same circumferential position, and such that the other end portion of the crossover portion in the circumferential direction is positioned radially outwardly of the other crossover portions located at the same circumferential position. Forming the stator in the so-called spiral shape enables a size reduction of the coil end portions. A method in which a coil insertion device is used described in Patent Document 1 may also be applied to the manufacture of the thus configured stator.

In such a case, the annular conductors are conventionally inserted into the slots of the stator core while deforming the crossover portions into a spiral shape. However, attempting to deform the crossover portions and insert the annular conductors into the slots at the same time often results in failing to appropriately insert the annular conductors at predetermined positions in the slots of the stator core, with the annular conductors deviating from targeted positions in the slots or the like.

### RELATED-ART DOCUMENTS

### Patent Documents

Patent Document 1: Japanese Patent Application Publication No. 2009-5434 (JP 2009-5434 A)

Patent Document 2: Japanese Patent Application Publication No. 2007-336720 (JP 2007-336720 A)

### SUMMARY OF THE INVENTION

### Problem to be Solved by the Invention

It is therefore desirable to provide a stator manufacturing method and a stator manufacturing apparatus capable of relatively easily manufacturing a stator in a so-called spiral shape.

### Means for Solving the Problem

The present invention provides a stator manufacturing method for manufacturing a stator by winding a coil around a stator core using a coil insertion device with a characteristic configuration, that is, a coil end portion of the coil that projects in an axial direction of the stator core from the stator core includes a plurality of crossover portions that extend in a circumferential direction of the stator core to connect between different slots of the stator core; each of the crossover portions is disposed such that one end portion of the crossover portion in the circumferential direction is positioned radially inwardly of the other crossover portions located at the same circumferential position, and such that the other end portion of the crossover portion in the circumferential direction is positioned radially outwardly of the other crossover portions located at the same circumferential position; and the coil insertion device includes a coil holder having a plurality of blades extending in the axial direction and arranged along the circumferential direction so as to face a plurality of teeth of the stator core, a position adjuster fitted with the plurality of blades to adjust a positional relationship between the blades, and a coil pusher that pushes the coil held by the coil holder toward the slots of the stator core, the stator manufacturing method including: a coil arrangement process in which a plurality of annular conductors constituting the coil are disposed in the coil holder such that a first portion of each of the annular conductors is inserted into a first catching gap formed between the blades, a second portion of each of the annular conductors is inserted into a second catching gap that is away from the first catching gap by a predetermined pitch, and a coupling portion, which connects between the first portion and the second portion of each of the plurality of annular conductors, passes through one side, in the axial direction, of the first portions of the other annular conductors disposed at positions overlapping the coupling portion as viewed in the axial direction; a coil deformation process which is performed after the coil arrangement process and in which the coupling portion of each of the plurality of annular conductors is deformed by moving the coil pusher in the axial direction along the blades to a set position at which an axial interval between the position adjuster and the coil pusher is shorter than an overall length of the annular conductors along the axial direction before deformation with the position adjuster fixed in position with respect to the coil holder; and a coil insertion process which is performed after the coil deformation process and in which the first portion and the second portion of each of the annular conductors are inserted into the slots by further moving the coil pusher in the axial direction.

In the coil arrangement process, the plurality of annular conductors are disposed in the coil holder as in the characteristic configuration described above to appropriately make preparations for the manufacture of a stator including a coil (here referred to as a “spiral coil”) in which each of the crossover portions is disposed such that one end portion of the crossover portion in the circumferential direction is positioned radially inwardly of the other crossover portions located at the same circumferential position, and such that the other end portion of the crossover portion in the circumferential direction is positioned radially outwardly of the other crossover portions located at the same circumferential position.

Then, in the coil deformation process executed after the coil arrangement process, the plurality of annular conductors are pressed between the position adjuster and the coil pusher to deform the coupling portions of the annular conductors. Consequently, the shape of the coupling portions may be caused to approximate the shape of the coil end portions after being wound around the stator core.

In this state, the coil insertion process is executed to dispose the coupling portion of each of the plurality of annular conductors after being deformed at a position at which the coupling portion projects from the stator core in the axial direction as the crossover portion, and the first portion and the second portion are inserted into the slots. At this time, the coupling portions of the annular conductors have already been deformed into a shape that is close to the shape of the coil end portions after being wound around the stator core in the coil deformation process, which facilitates insertion of the annular conductors into the slots. Hence, it is possible to relatively easily manufacture a stator including a spiral coil.

Here, in the coil insertion process, the position adjuster is preferably moved in the axial direction in accordance with axial movement of the coil pusher while maintaining the axial interval between the position adjuster and the coil pusher.

According to the configuration, the coupling portions pressed between the position adjuster and the coil pusher to be deformed may be moved in the axial direction in the same state without being further deformed. Hence, the first portions and the second portions of the annular conductors may be inserted into the slots while suppressing application of an unwanted stress to the coupling portions.

In the coil deformation process, the axial interval between the position adjuster and the coil pusher is preferably set to be shorter than an axial length of the stator core with the coil pusher located at the set position.

In a common coil insertion device, the coil pusher has portions (here referred to as “slot opening arranged portions”) that project radially along the radial direction to be disposed in opening portions of the slots of the stator core. In the case where the coil insertion device includes the position adjuster, the position adjuster may be configured to have similar slot opening arranged portions.

According to the configuration, at least the slot opening arranged portions of the coil pusher or the slot opening arranged portions of the position adjuster are disposed in the opening portions of the slots, and thus the positional relationship between the blades may be maintained by at least one of the coil pusher and the position adjuster. Hence, the coil insertion process may be executed while appropriately maintaining the relative positional relationship between the catching gaps between the blades and the slots of the stator core. Thus, it is possible to reliably insert the first portions and the second portions of the annular conductors into the slots.

Preferably, the annular conductors are constituted from a bundle of a plurality of linear conductors; and in the coil deformation process, the axial interval between the position adjuster and the coil pusher with the coil pusher located at the set position is set such that the axial interval matches a length of the first portions or the second portions along the axial direction with the plurality of linear conductors arranged with no gap in the catching gaps.

According to the configuration, in deforming the coupling portions of the annular conductors in the coil deformation process, the annular conductors are pressed until there is no gap between the plurality of linear conductors constituting the annular conductors, which reliably deforms the coupling portions. This also enhances the spatial density of the coupling portions, and allows a size reduction of the coil end portions.

Preferably, the coil pusher has a body portion in a shape of a disc formed along the plurality of blades, and a swelling portion that swells toward the position adjuster from the body portion in the axial direction, the swelling portion being formed to be smaller in diameter than the body portion; and in the coil deformation process, the annular conductors are supported in abutment with an outer peripheral surface of the swelling portion, and the coupling portions of the annular conductors are deformed with movement of the annular conductors toward a radially inner side restrained.

According to the configuration, in the stator after being completed, the imbalance in size between the coil end portions on both sides in the axial direction may be reduced. Optimizing the balance in size between the coil end portions effectively suppresses the annular conductors being caught or the like, which facilitates insertion of the annular conductors into the slots.

The present invention also provides a stator manufacturing apparatus for manufacturing a stator by winding a coil around a stator core with a characteristic configuration, that is, the stator manufacturing apparatus includes: a coil holder having a plurality of blades extending in an axial direction and arranged along a circumferential direction so as to face a plurality of teeth of the stator core; a position adjuster fitted with the plurality of blades to adjust a positional relationship between the blades; a coil pusher that pushes the coil held by the coil holder toward slots of the stator core; and a control section that controls operation of at least the position adjuster and the coil pusher, and with a plurality of annular conductors constituting the coil disposed such that a first portion of each of the annular conductors is inserted into a first catching gap formed between the blades, a second portion of each of the annular conductors is inserted into a second catching gap that is away from the first catching gap by a predetermined pitch, and a coupling portion, which connects between the first portion and the second portion of each of the plurality of annular conductors, passes through one side, in the axial direction, of the first portions of the other annular conductors disposed at positions overlapping the coupling portion as viewed in the axial direction, the control section executes: a coil deformation process in which the coupling portion of each of the plurality of annular conductors is deformed by moving the coil pusher in the axial direction along the blades to a set position at which an axial interval between the position adjuster and the coil pusher is shorter than an overall length of the annular conductors along the axial direction before deformation with the position adjuster fixed in position with respect to the coil holder; and a coil insertion process in which the first portion and the second portion of each of the annular conductors are inserted into the slots by further moving the coil pusher in the axial direction, the coil insertion process being executed after the coil deformation process.

According to the characteristic configuration, it is possible to relatively easily manufacture a coil in which the coil end portion which projects in the axial direction of the stator core from the stator core includes the plurality of crossover portions which extend in the circumferential direction of the stator core to connect between different slots of the stator core, and in which each of the crossover portions is disposed such that one end portion of the crossover portion in the circumferential direction is positioned radially inwardly of the other crossover portions located at the same circumferential position, and such that the other end portion of the crossover portion in the circumferential direction is positioned radially outwardly of the other crossover portions located at the same circumferential position.

That is, with the plurality of annular conductors disposed in the coil holder as in the characteristic configuration described above, it is possible to appropriately make preparations for the manufacture of a stator including a coil (a spiral coil) in which each of the crossover portions is disposed such that one end portion of the crossover portion in the circumferential direction is positioned radially inwardly of the other crossover portions located at the same circumferential position, and such that the other end portion of the crossover portion in the circumferential direction is positioned radially outwardly of the other crossover portions located at the same circumferential position.

Then, in the coil deformation process executed thereafter, the plurality of annular conductors are pressed between the position adjuster and the coil pusher to deform the coupling portions of the annular conductors. Consequently, the shape of the coupling portions may be caused to approximate the shape of the coil end portions after being wound around the stator core.

In this state, the coil insertion process is executed to dispose the coupling portion of each of the plurality of annular conductors after being deformed at a position at which the coupling portion projects from the stator core in the axial direction as the crossover portion, and the first portion and the second portion are inserted into the slots. At this time, the coupling portions of the annular conductors have already been deformed into a shape that is close to the shape of the coil end portions after being wound around the stator core in the coil deformation process, which facilitates insertion of the annular conductors into the slots. Hence, it is possible to provide a stator manufacturing apparatus capable of relatively easily manufacturing a stator including a spiral coil.

Here, in the coil insertion process, the control section preferably causes the position adjuster to be moved in the axial direction in accordance with axial movement of the coil pusher while maintaining the axial interval between the position adjuster and the coil pusher.

According to the configuration, the coupling portions pressed between the position adjuster and the coil pusher to be deformed may be moved in the axial direction in the same state without being further deformed. Hence, the first portions and the second portions of the annular conductors may be inserted into the slots while suppressing application of an unwanted stress to the coupling portions.

In the coil deformation process, the control section preferably sets the axial interval between the position adjuster and the coil pusher to be shorter than an axial length of the stator core with the coil pusher located at the set position.

In a common stator manufacturing apparatus, the coil pusher has portions (slot opening arranged portions) that project radially along the radial direction to be disposed in opening portions of the slots of the stator core. In the case where the stator manufacturing apparatus includes the position adjuster, the position adjuster may be configured to have similar slot opening arranged portions.

According to the configuration, at least the slot opening arranged portions of the coil pusher or the slot opening arranged portions of the position adjuster are disposed in the opening portions of the slots, and thus the positional relationship between the blades may be maintained by at least one of the coil pusher and the position adjuster. Hence, the coil insertion process may be executed while appropriately maintaining the relative positional relationship between the catching gaps between the blades and the slots of the stator core. Thus, it is possible to reliably insert the first portions and the second portions of the annular conductors into the slots.

Preferably, the annular conductors are constituted from a bundle of a plurality of linear conductors; and in the coil deformation process, the control section sets the axial interval between the position adjuster and the coil pusher with the coil pusher located at the set position such that the axial interval matches a length of the first portions or the second portions along the axial direction with the plurality of linear conductors arranged with no gap in the catching gaps.

According to the configuration, in deforming the coupling portions of the annular conductors in the coil deformation process, the annular conductors are pressed until there is no gap between the plurality of linear conductors constituting the annular conductors, which reliably deforms the coupling portions. This also enhances the spatial density of the coupling portions, and allows a size reduction of the coil end portions.

Preferably, the coil pusher has a body portion in a shape of a disc formed along the plurality of blades, and a swelling portion that swells toward the position adjuster from the body portion in the axial direction, the swelling portion being formed to be smaller in diameter than the body portion; and in the coil deformation process, the control section causes the annular conductors to be supported in abutment with an outer peripheral surface of the swelling portion, and causes the coupling portions of the annular conductors to be deformed with movement of the annular conductors toward a radially inner side restrained.

According to the configuration, in the stator after being completed, the imbalance in size between the coil end portions on both sides in the axial direction may be reduced. Optimizing the balance in size between the coil end portions effectively suppresses the annular conductors being caught or the like, which facilitates insertion of the annular conductors into the slots.

### BRIEF DESCRIPTION OF THE DRAWINGS

FIG. 1 is a perspective view of a stator according to an embodiment.

FIG. 2 is a plan view schematically illustrating spiral coil end portions as seen from the axial direction.

FIG. 3 illustrates a schematic configuration of a stator manufacturing apparatus according to the embodiment.

FIG. 4 is a IV-IV sectional view of FIG. 3.

FIG. 5 is a V-V sectional view of FIG. 3.

FIG. 6 is a flowchart illustrating manufacturing processes of a stator manufacturing method according to the embodiment.

FIG. 7 is a schematic view illustrating the state of arrangement of annular conductors in a coil arrangement process.

FIG. 8 illustrates the state of a coil insertion device in a coil deformation process.

FIG. 9 is a schematic view illustrating the state of arrangement of the annular conductors in a coil deformation process.

FIG. 10 illustrates the state of the coil insertion device in one phase of a coil insertion process.

FIG. 11 is a schematic view illustrating the state of arrangement of the annular conductors in one phase of the coil insertion process.

FIG. 12 illustrates the state of the coil insertion device in the final phase of the coil insertion process.

FIG. 13 illustrates the state of the coil insertion device in a coil shaping process.

### MODES FOR CARRYING OUT THE INVENTION

A stator manufacturing method according to the present invention will be described with reference to the drawings. In the stator manufacturing method according to the present invention, a stator 1 is manufactured by winding a coil 3 around a stator core 2 using a stator manufacturing apparatus 100 (a coil insertion device 5). With the stator manufacturing method according to an embodiment, it is possible to relatively easily manufacture a stator 1 in a so-called spiral shape. In the following, the configuration of the stator 1 to be manufactured, the configuration of the coil insertion device 5 used during the manufacture, and the stator manufacturing method in which the coil insertion device 5 is used are described sequentially.

In the following description, unless specifically differentiated, the “axial direction L”, the “circumferential direction C”, and the “radial direction R” are defined with reference to an axis X of a cylindrical core reference surface 21 of the stator core 2 (for example, the inner peripheral surface of the stator core 2). For each of members of the coil insertion device 5, the axis X of the core reference surface 21 with the stator core 2 mounted (set) to the coil insertion device 5 in a normal arrangement is defined as a reference.

Terms related to the direction, the position, and so forth (such as “parallel” and “match”, for example) of each member may allow a difference due to an error that may be tolerated during manufacture.

### 1. Configuration of Stator

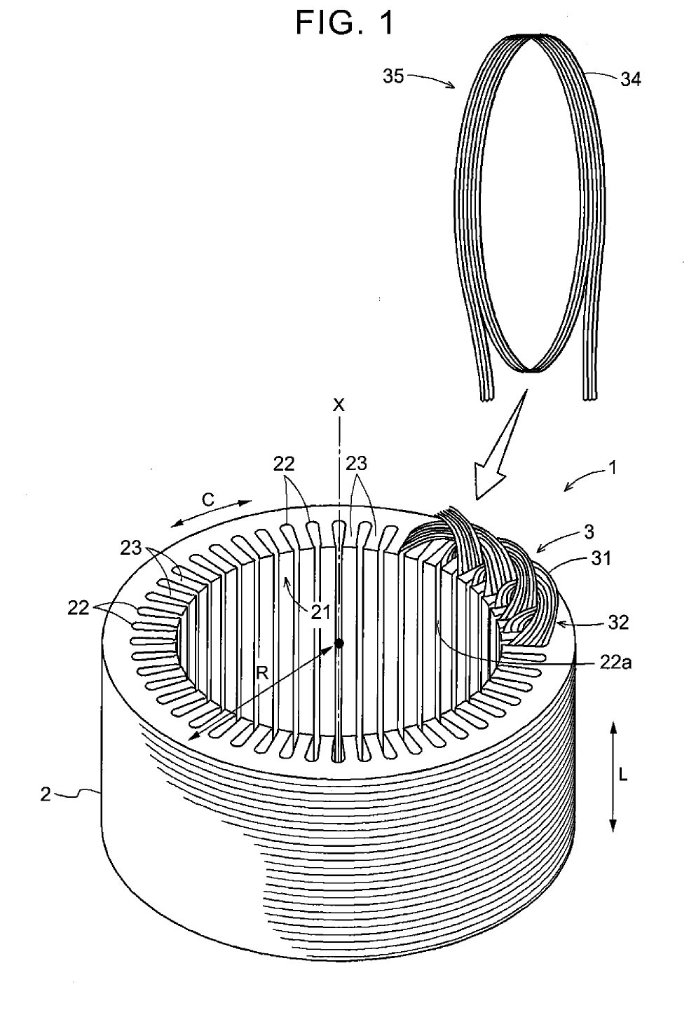

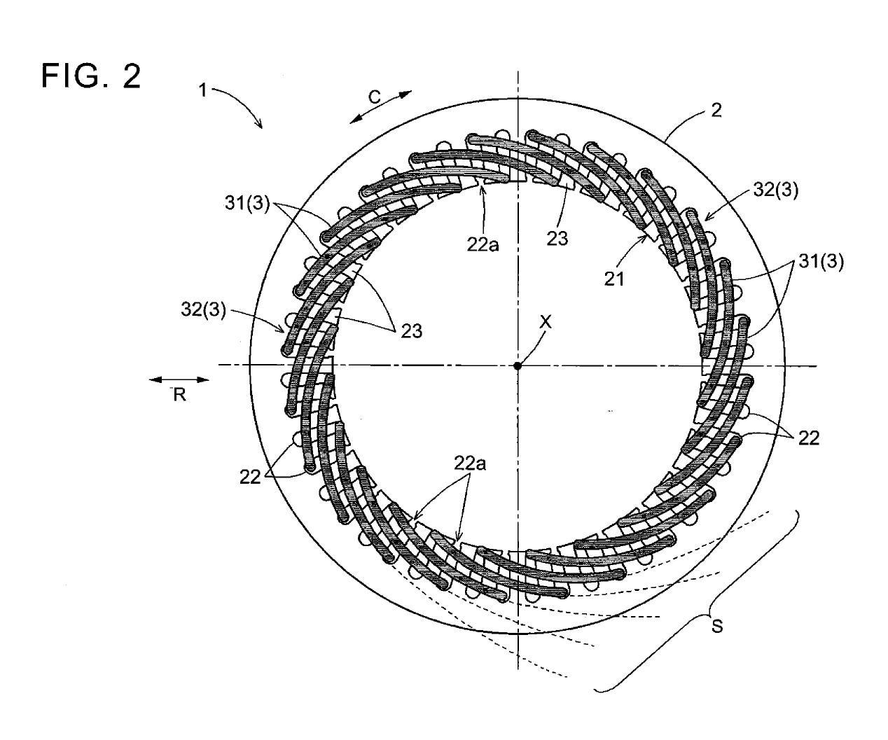

The configuration of a stator 1 according to the embodiment will be described with reference to FIGS. 1 and 2. The stator 1 is a stator of a rotary electric machine of an inner rotor type. Here, the term “rotary electric machine” refers to any of a motor (electric motor), a generator (electric generator), and a motor generator that functions both as a motor and as a generator as necessary. As illustrated in FIG. 1, the stator 1 includes a stator core 2 and a coil 3. In FIG. 1, in order to avoid complication, only a part of a coil end portion 32 which is a portion of the coil 3 that projects in the axial direction L from the stator core 2 is illustrated, and the other part of the coil end portion 32 is not illustrated.

The stator core 2 is formed using a magnetic material. The stator core 2 has a plurality of slots 22 disposed in a distributed manner in the circumferential direction C in the cylindrical core reference surface 21, and a plurality of teeth 23 each formed between two slots 22 that are adjacent to each other in the circumferential direction C. Here, the “cylindrical core reference surface 21” refers to an imaginary surface serving as a reference for the arrangement and configuration of the slots 22. In the embodiment, as illustrated in FIG. 1, the core reference surface 21 is a core inner peripheral surface which is an imaginary cylindrical surface including end surfaces of the plurality of teeth 23 on the inner side in the radial direction R, the teeth 23 being each formed between two adjacent slots 22. The outer peripheral surface of the stator core 2 or the like may be defined as the core reference surface 21.

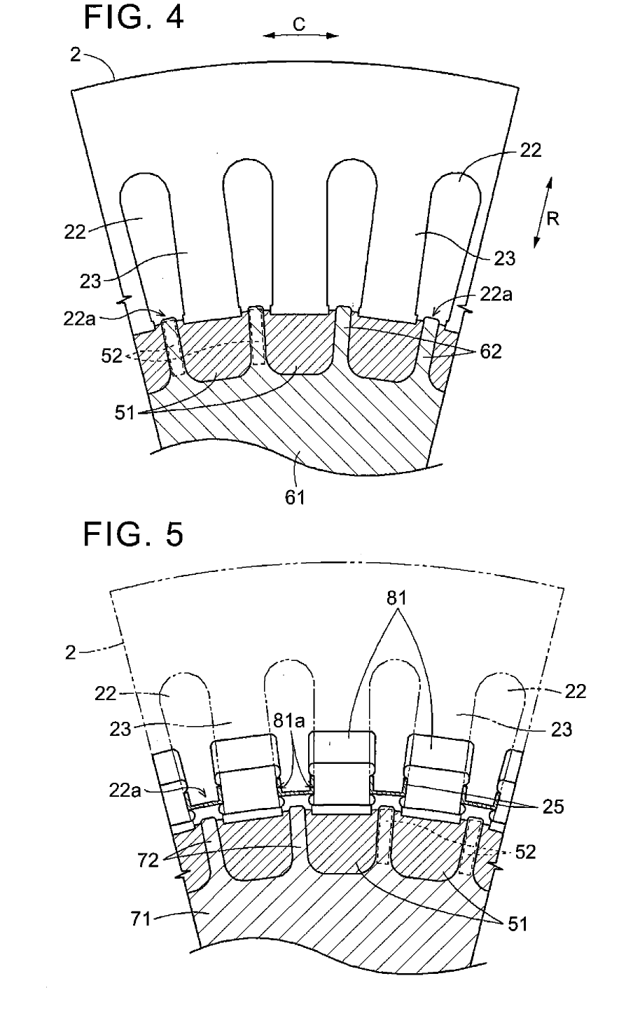

The plurality of slots 22 are disposed in a distributed manner at constant intervals along the circumferential direction C. The slots 22 are each formed to extend in the axial direction L, and to extend radially in the radial direction R from the axis X of the stator core 2. The slots 22 have the same shape as each other, and are each formed in the shape of a groove extending in the axial direction L and in the radial direction R and having a predetermined width in the circumferential direction C. A sheet-like insulating member (not illustrated) is provided on the inner wall surface of each of the slots 22. The slots 22 each have an inner peripheral opening portion 22a that opens inward in the radial direction R (that opens in the inner peripheral surface of the stator core 2). The opening width of the inner peripheral opening portion 22a of each of the slots 22 is narrower than a portion of the slot 22 on the outer side in the radial direction R. That is, the slots 22 according to the embodiment are constituted as semi-open slots. A wedge 25 constituted from a sheet-like member made of a synthetic resin is disposed at an end portion of each of the slots 22 on the inner side in the radial direction R so as to block the inner peripheral opening portion 22a (see FIG. 5).

The plurality of teeth 23 are each formed between two slots 22 that are adjacent to each other, and disposed in a distributed manner at constant intervals along the circumferential direction C. The teeth 23 have the same shape as each other, and are each formed in the shape of a thick plate extending in the axial direction L and in the radial direction R and having a predetermined width in the circumferential direction C. In the embodiment, the teeth 23 are each formed such that two side surfaces of the teeth 23 that face in the circumferential direction C extend in parallel with each other. That is, the teeth 23 according to the embodiment are constituted as parallel teeth.

In the embodiment, the rotary electric machine is an AC motor driven by multi-phase (in the example, three-phase) AC. In the example, the coil 3 of the stator 1 is divided into a U-phase coil, a V-phase coil, and a W-phase coil corresponding to the three phases (U-phase, V-phase, and W-phase). In the stator core 2, correspondingly, slots 22 for U-phase, V-phase, and W-phase are disposed so as to repeatedly appear along the circumferential direction C. In the example, in the stator core 2, the slots 22 are disposed such that two slots 22 for each phase repeatedly appear along the circumferential direction C. Correspondingly, the coil 3 is wound around the stator core 2 such that two coils 3 for each phase repeatedly appear along the circumferential direction C.

The coil 3 has the coil end portion 32 which projects in the axial direction L of the stator core 2 from the stator core 2. The coil end portion 32 includes a plurality of crossover portions 31 that extend in the circumferential direction C of the stator core 2 to connect between different slots 22 of the stator core 2. As illustrated in FIG. 1, the crossover portions 31 are disposed so as to connect two slots 22 that are away from each other by a pitch of five slots. In addition, the crossover portions 31 are each disposed so as to be intertwined with other crossover portions 31 that extend from four slots 22 positioned between two slots 22 on both sides of the crossover portion 31 with portions of the crossover portions 31 overlapping each other as viewed in the axial direction L, the circumferential direction C, and the radial direction R. The phrase “overlap as viewed in a predetermined direction” as used for the arrangement of two members means that when the viewing direction is determined as the predetermined direction and the viewpoint is moved in directions orthogonal to the viewing direction, the two members are seen as overlapping each other from at least some positions of the viewpoint.

The crossover portions 31 are each disposed such that an end portion of the crossover portion 31 on one side in the circumferential direction C (on the side in the clockwise direction in FIG. 2) is positioned on the inner side in the radial direction R with respect to the other crossover portions 31 located at the same position in the circumferential direction C, and such that an end portion of the crossover portion 31 on the other side in the circumferential direction C (on the side in the counterclockwise direction in FIG. 2) is positioned on the outer side in the radial direction R with respect to the other crossover portions 31 located at the same position in the circumferential direction C. The crossover portions 31 are disposed so as to extend from the inner side in the radial direction R toward the outer side in the radial direction R from the one side in the circumferential direction C toward the other side in the circumferential direction C, and disposed such that two crossover portions 31 that are adjacent to each other in the circumferential direction C partially overlap each other as viewed in the radial direction R.

The plurality of crossover portions 31 are disposed, in design, along a plurality of spiral lines S that extend outward in the radial direction R from the axis X of the stator core 2 as viewed in the axial direction L. Here, the “spiral lines S” are spiral plane curves (including plane lines, plane polygonal curves, and so forth). The phrase “extend outward in the radial direction R from the axis X” represents extending at least outward in the radial direction R from the axis X side, and does not require that imaginary extension lines of the spiral lines S pass through the axis X. FIG. 2 schematically illustrates the plurality of crossover portions 31 as seen from the axial direction L. Accordingly, the coil 3 according to the embodiment has the coil end portion (spiral coil end portion) 32 in which the plurality of crossover portions 31 are disposed in a spiral shape as a whole as viewed in the axial direction L. The coil 3 having such a spiral coil end portion 32 is hereinafter occasionally referred to as a “spiral coil 3”. In the example, only one set of the spiral coil 3 is provided.

The coil 3 is constituted from a plurality of annular conductors 35 to be discussed later. The annular conductors 35 are constituted from a bundle of a plurality of linear conductors 34. The linear conductors 34 are conductors in a linear shape constituted from metal such as copper or aluminum, for example, and an insulating film constituted from a resin or the like is formed on the surface of the linear conductors 34. The term “plurality of” means that a plurality of linear conductors 34 are provided in each sectional surface that is orthogonal to the direction of extension of the linear conductors 34, and the linear conductors 34 themselves may be connected to each other as a whole. In the embodiment, a set of three linear conductors 34 are circulated a plurality of times to constitute annular conductors 35 constituted from a bundle of a plurality of linear conductors 34. A single linear conductor 34 or a set of K linear conductors 34 (K represents an integer of two or more) may be circulated a plurality of times to constitute annular conductors 35 constituted from a bundle of a plurality of linear conductors 34. A variety of methods known in the art may be used to wind the coil 3, which is constituted from the plurality of annular conductors 35, around the stator core 2. In the example, the coil 3 is wound around the stator core 2 by lap winding and distributed winding.

### 2. Configuration of Coil Insertion Device

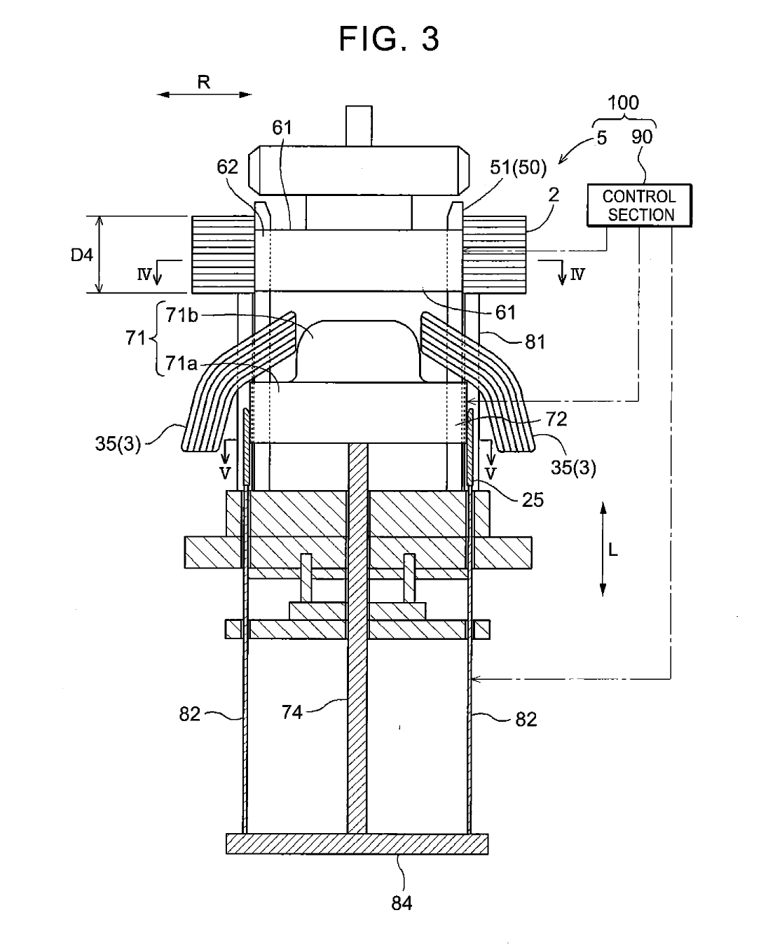

The configuration of the coil insertion device 5 according to the embodiment will be described with reference to FIGS. 3 to 5. As illustrated in FIG. 3, the coil insertion device 5 includes a coil holder 50, a position adjuster 61, and a coil pusher 71 as its main components. The coil insertion device 5 also includes wedge guiding members 81 and wedge pushers 82.

The coil holder 50 is a member that holds the coil 3, and has a plurality of blades 51. In the embodiment, the coil holder 50 has a number of blades 51, the number being the same as that of the teeth 23 of the stator core 2. As illustrated in FIG. 4, the blades 51 are arranged along the circumferential direction C so as to face the plurality of teeth 23. As illustrated in FIG. 3, the blades 51 are formed in a bar shape to extend over a predetermined length (that is sufficiently longer than the axial length D4 of the stator core 2 in the example) along the axial direction L. Consequently, the plurality of blades 51 are disposed in a cylindrical shape as a whole. The blades 51 are positioned and held with their lower end portions fastened and fixed to a blade holder (not illustrated) of the coil holder 50.

A catching gap 52 (see FIG. 4 etc.) is formed between two blades 51 that are adjacent to each other as a gap in the circumferential direction having a constant width in the circumferential direction C. In the embodiment, a number of catching gaps 52 are formed, the number being the same as that of the slots 22 of the stator core 2. The catching gaps 52 communicate with the inner peripheral opening portions 22a of the slots 22. Predetermined portions of the annular conductors 35 constituting the coil 3 are inserted into and caught in the catching gaps 52 as described below. The coil holder 50 can hold the coil 3 with the plurality of annular conductors 35 caught in the catching gaps 52.

The position adjuster 61 is a member that is fitted with the plurality of blades 51 to adjust the positional relationship between the blades 51. The position adjuster 61 is formed in the shape of a disc having a predetermined thickness in the axial direction L. The outer shape of the disc-shaped portion extends along the inner peripheral surfaces of the plurality of blades 51 disposed in a cylindrical shape. The position adjuster 61 is suspended from above the blades 51 (the upper side in FIG. 3), and slidable along the axial direction L (along the direction of extension of the blades 51) by a predetermined drive mechanism.

As illustrated in FIG. 4, the position adjuster 61 has a plurality of projecting teeth 62 provided at an end portion on the outer side in the radial direction R to project radially outward in the radial direction R. The projecting teeth 62 have the same shape as each other, and are each formed in the shape of a plate extending in the axial direction L and in the radial direction R and having a predetermined width in the circumferential direction C. A number of projecting teeth 62 are formed, the number being the same as that of the catching gaps 52 of the coil holder 50. The projecting teeth 62 are inserted into the catching gaps 52 with the position adjuster 61 positioned below the upper end portions of the blades 51. This enables the position adjuster 61 to adjust the positional relationship between the blades 51 in the circumferential direction C by suppressing fluctuations in distance between the blades 51 in the circumferential direction C. The projecting teeth 62 have such a length in the radial direction R that their distal end portions (in the example, their end portions on the outer side in the radial direction R) pass through the catching gaps 52 to reach the inner peripheral opening portions 22a of the stator core 2.

In the embodiment, in order to make the coil insertion device 5 applicable to the manufacture of the spiral coil 3, the coil holder 50 is provided with a number of blades 51, the number being the same as that of the teeth 23, as discussed above. Therefore, the width of the blades 51 in the circumferential direction C is very narrow. On the other hand, the length of the blades 51 in the axial direction L is relatively long as illustrated in FIG. 3. Thus, the upper end portions of the blades 51 may not be positioned accurately with only the lower end portions thereof fastened and fixed. Therefore, adjusting the positional relationship between the blades 51 around the upper end portions of the blades 51 using the position adjuster 61 enables accurate positioning of the plurality of blades 51 even in the coil insertion device 5 configured as described above.

The coil pusher 71 is a member that pushes the coil 3 held by the coil holder 50 toward the slots 22 of the stator core 2. As illustrated in FIG. 3, the coil pusher 71 has a body portion 71a and a swelling portion 71b. The body portion 71a is formed in the shape of a disc having a predetermined thickness in the axial direction L. The outer shape of the body portion 71a extends along the inner peripheral surfaces of the plurality of blades 51 disposed in a cylindrical shape. The swelling portion 71b swells toward the position adjuster 61 (upward) in the axial direction L from the body portion 71a. The swelling portion 71b is formed concentrically with the body portion 71a to be smaller in diameter than the body portion 71a. The coil pusher 71 is disposed on the side of the lower end portions of the blades 51, and disposed on the opposite side (the lower side in FIG. 3) of the coil 3 held by the coil holder 50 (the plurality of annular conductors 35) from the stator core 2 in the axial direction L. The coil pusher 71 is coupled to a predetermined drive mechanism via a drive shaft 74, and is slidable along the axial direction L (along the direction of extension of the blades 51) by operation of the drive mechanism. The position adjuster 61 and the coil pusher 71 discussed above are configured to be independently slidable.

As illustrated in FIG. 5, the coil pusher 71 has a plurality of pushing teeth 72 provided at an end portion on the outer side in the radial direction R to project radially outward in the radial direction R. In FIG. 5, in order to clearly indicate the relative positional relationship with the stator core 2, the stator core 2 disposed at different positions in the axial direction L is indicated by the dash-double-dot line. The pushing teeth 72 have the same shape as each other, and are each formed in the shape of a plate extending in the axial direction L and in the radial direction R and having a predetermined width in the circumferential direction C. A number of pushing teeth 72 are formed, the number being the same as that of the catching gaps 52 of the coil holder 50. The pushing teeth 72 are inserted into the catching gaps 52. This enables the coil pusher 71 to adjust the positional relationship between the plurality of blades 51 in the circumferential direction C. In the embodiment, as with the projecting teeth 62, the pushing teeth 72 have such a length in the radial direction R that their distal end portions (in the example, their end portions on the outer side in the radial direction R) pass through the catching gaps 52 to reach the inner peripheral opening portions 22a of the stator core 2.

The coil pusher 71, which moves toward the stator core 2 along the axial direction L (upward in FIG. 3), pushes up the plurality of annular conductors 35 held by the coil holder 50. In this event, the pushing teeth 72 push portions of the annular conductors 35 inserted into the catching gaps 52 of the coil holder 50 and surrounding portions outward in the radial direction R to insert such portions into the corresponding slots 22.

The wedge guiding members 81 are each a member that guides the wedge 25 to a predetermined position in each slot 22 of the stator core 2. The wedge guiding members 81 are disposed adjacently on the outer side, in the radial direction R, of the plurality of blades 51 disposed in a cylindrical shape. A number of wedge guiding members 81 are provided, the number being the same as that of the blades 51 and the teeth 23 of the stator core 2, and disposed at the same positions as the blades 51 and the teeth 23 in the circumferential direction C. The wedge guiding members 81 are disposed on the outer side of the blades 51 in the radial direction R with a minute gap between the blades 51 and the wedge guiding members 81. The wedge guiding members 81 are each formed in a bar shape to extend over a predetermined length along the axial direction L. Consequently, the plurality of wedge guiding members 81 are disposed in a cylindrical shape as a whole. The wedge guiding members 81 are positioned and held with their lower end portions fastened and fixed to a body case (not illustrated).

As illustrated in FIG. 5, the wedge guiding members 81 each have guiding grooves 81a in both sides surfaces thereof in the circumferential direction C. The wedges 25, which are folded in a C-shape (an angular U-shape) in cross section in the example, are each disposed between two wedge guiding members 81 that are adjacent to each other (between two guiding grooves 81a that face each other in the circumferential direction C). The upper end portions of the wedge guiding members 81 abut against the lower end surface of the stator core 2.

The wedge pushers 82 are members that push up the wedges 25 along the wedge guiding members 81 (guiding grooves 81a). The wedge pushers 82 are coupled to the drive shaft 74 via a coupling member 84 formed in a flat plate shape, and slidable along the axial direction L (along the direction of extension of the blades 51). In this event, in the embodiment, the wedge pushers 82 slide in coordination with the coil pusher 71. Consequently, as the coil 3 is inserted into the slots 22 by the coil pusher 71, the wedge pushers 82 push up the plurality of wedges 25, which causes the wedges 25 to block the inner peripheral opening portions 22a.

In the embodiment, as illustrated in FIG. 3, a control section 90 is provided to control operation of various components of the coil insertion device 5. The control section 90 controls operation of each of at least the position adjuster 61 and the coil pusher 71 via a drive mechanism (not illustrated). In the embodiment, the control section 90 is configured to also control operation of the wedge pushers 82 via a drive mechanism (not illustrated). In FIG. 3, broken arrows are used to schematically indicate that the control section 90 controls operation of the various components of the coil insertion device 5. The control section 90 causes such components to operate cooperatively to execute processes P3 to P5 to be described below. In the embodiment, a coil preparation process P1 and a coil arrangement process P2 are not controlled by the control section 90, but executed separately. In the embodiment, the stator manufacturing apparatus 100 is constituted from the coil insertion device 5 and the control section 90.

### 3. Stator Manufacturing Method

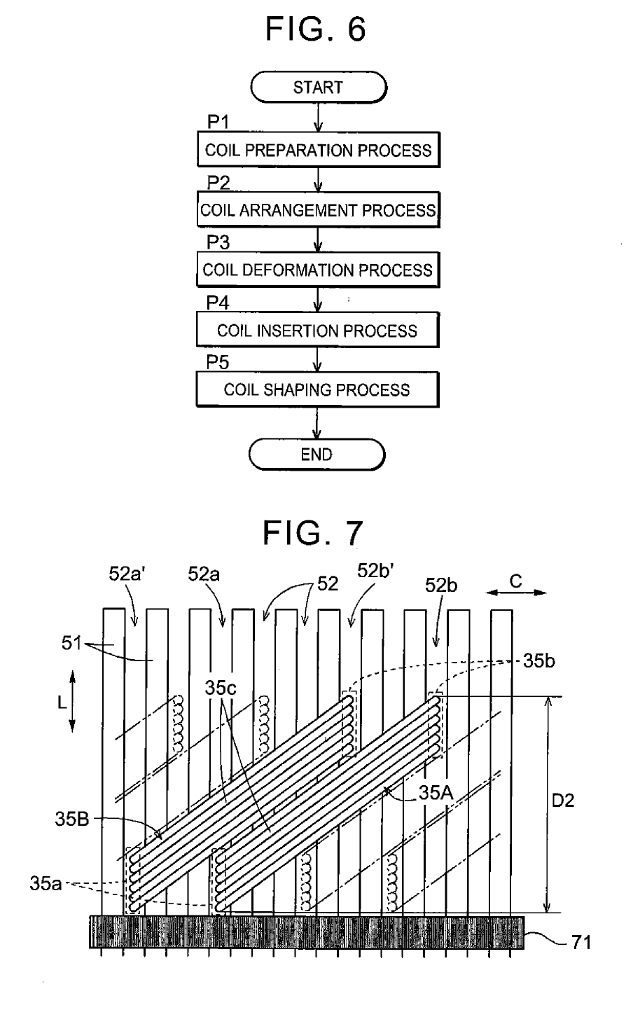

The manufacture of the stator 1 according to the embodiment performed using the stator manufacturing apparatus 100 (the coil insertion device 5 and the control section 90) discussed above will be described with reference to FIGS. 6 to 13. As illustrated in FIG. 6, the stator 1 according to the embodiment is manufactured through the coil preparation process P1, the coil arrangement process P2, the coil deformation process P3, the coil insertion process P4, and the coil shaping process P5. The processes P1 to P5 are executed in the order of description. The processes will be sequentially described below. The description of the processes P3 to P5 is substantially the same as the description of the function of the control section 90 provided in the stator manufacturing apparatus 100.

3-1. Coil Preparation Process

In the coil preparation process P1, a plurality of annular conductors 35 constituting the coil 3 are prepared. In the embodiment, annular conductors 35 are formed using a winding device (not illustrated) that is different from the coil insertion device 5. Specifically, a set of three linear conductors 34 are circulated around a winding frame provided in the winding device a plurality of times to form annular conductors 35 (see FIG. 1) constituted as a bundle of a plurality of linear conductors 34. In the example, a number of annular conductors 35 are formed, the number being half the number of the slots 22 of the stator core 2. The plurality of annular conductors 35 prepared are provided for the coil arrangement process P2.

3-2. Coil Arrangement Process

In the coil arrangement process P2, the plurality of annular conductors 35 constituting the coil 3 are disposed in the coil holder 50. In the embodiment, the annular conductors 35 are disposed in the coil holder 50 using a coil arranging device (not illustrated) that is different from the coil insertion device 5. The coil arrangement process P2 is executed with the position adjuster 61 positioned further above the upper end portions of the blades 51 and with the stator core 2 not mounted to the coil insertion device 5. In addition, the coil pusher 71 and the wedge pushers 82 are positioned on the side of the lower end portion of the slidable range.

In the coil arrangement process P2, the plurality of annular conductors 35 are inserted in the axial direction L so as to be disposed as caught in predetermined two of the plurality of catching gaps 52 of the coil holder 50. FIG. 7 schematically illustrates a state in which the plurality of annular conductors 35 are disposed in the coil holder 50 as seen from the radial direction R. As illustrated in the drawing, the annular conductors 35 are each disposed as caught in two catching gaps 52 that are away from each other by five pitches (that is equal to a pitch of five slots in the example). In this event, the annular conductors 35 are each disposed such that the direction of extension of portions of the linear conductors 34 constituting the annular conductor 35 (a coupling portion 35c to be discussed later), which connect between the two catching gaps 52, is inclined with respect to the axial direction L (the direction of extension of the blades 51).

The arrangement of the annular conductors 35 will be described more specifically with focus on a specific one of the annular conductors 35 (which is referred to as a “specific annular conductor 35A”) in FIG. 7. First, a first portion 35a, which is a part of the specific annular conductor 35A, is inserted into one (a first catching gap 52a) of the catching gaps 52 formed between the blades 51 from the side of the upper end portions of the blades 51. The first portion 35a is further moved toward the lower portion of the first catching gap 52a along the blades 51. The first portion 35a is disposed so as to be positioned around the upper end surface of the body portion 71a of the coil pusher 71.

Next, a second portion 35b, which is another part of the specific annular conductor 35A, is inserted into a second catching gap 52b, which is away from the first catching gap 52a by five pitches, from the side of the upper end portions of the blades 51. The second portion 35b is moved along the blades 51, and disposed so as to be positioned on one side (in the example, the upper side in FIG. 7), in the axial direction L, with respect to the first portion 35a of the specific annular conductor 35A. The coupling portion 35c, which connects between the first portion 35a and the second portion 35b, is disposed so as to be inclined with respect to the axial direction L.

The first portion 35a of an annular conductor 35 (which is referred to as a “specific annular conductor 35B”) that is different from the specific annular conductor 35A is inserted into a catching gap 52 (a first catching gap 52a′) that is away from the first catching gap 52a by two pitches toward the side opposite to the second catching gap 52b, and the second portion 35b of the specific annular conductor 35B is inserted into a catching gap 52 (a second catching gap 52b′) that is away from the second catching gap 52a by two pitches. The coupling portion 35c, which connects between the first portion 35a and the second portion 35b of the specific annular conductor 35B, is disposed so as to be inclined with respect to the axial direction L. This operation is sequentially performed over the entire circumference of the stator core 2.

The respective first portions 35a of the annular conductor 35 that is the last to be inserted and the annular conductor 35 that is the second last to be inserted are inserted with the respective second portions 35b of the specific annular conductor 35A and the specific annular conductor 35B disengaged from the catching gaps 52 and positioned above the upper end portions of the blades 51 such that the respective first portions 35a of the last and second-last inserted annular conductors 35 slip under the respective second portions 35b of the specific annular conductors 35A and 35B. After that, the second portion 35b of the specific annular conductor 35A and the second portion 35b of the specific annular conductor 35B are returned to the respective predetermined positions in the second catching gaps 52b and 52b′.

With the plurality of annular conductors 35 disposed in the coil holder 50 in this way, the coupling portion 35c, which connects between the first portion 35a and the second portion 35b of each of the plurality of annular conductors 35, is disposed so as to extend from one side in the circumferential direction C (in the example, the right side in FIG. 7) toward the other side in the circumferential direction C (in the example, the left side in FIG. 7) from one side in the axial direction L (in the example, the upper side in FIG. 7) toward the other side in the axial direction L (in the example, the lower side in FIG. 7). Then, two coupling portions 35c that are adjacent to each other in the circumferential direction C are disposed so as to partially overlap each other as viewed in the axial direction L. In addition, the coupling portion 35c of each of the annular conductors 35 is disposed so as to pass through the one side, in the axial direction L, of the first portions 35a of other annular conductors 35 disposed at positions overlapping the coupling portion 35c as viewed in the axial direction L. The second portion 35b of each of the annular conductors 35 is disposed so as to pass through the one side, in the axial direction L, of the coupling portions 35c and the first portions 35a of other annular conductors 35 disposed at positions overlapping the second portion 35b as viewed in the axial direction L. The overall length D2 of the annular conductors 35 along the axial direction L (along the blades 51) with the coil arrangement process P2 completed coincides with the length of the separation between the lower end portions of the first portions 35a and the upper end portions of the second portions 35b along the axial direction L. In the coil holder 50, in addition, the annular conductors 35 constituting the coil 3 for all the three phases are disposed collectively in the example. The coil holder 50 which holds the plurality of annular conductors 35 is provided for the coil deformation process P3. Between the coil arrangement process P2 and the coil deformation process P3, the stator core 2 is mounted at a predetermined position of the coil insertion device 5. In addition, the position adjuster 61 is moved downward along the axial direction L to a position at which the respective lower end surfaces of the stator core 2 and the position adjuster 61 are flush with each other.

3-3. Coil Deformation Process

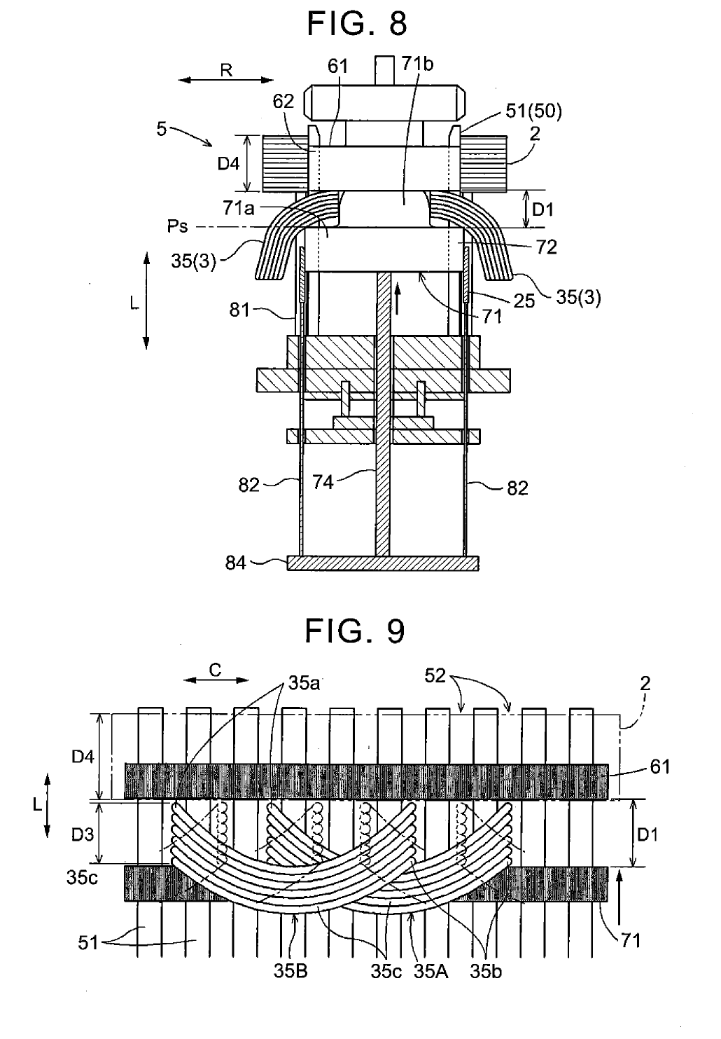

In the coil deformation process P3, the coupling portions 35c of the plurality of annular conductors 35 are deformed. As illustrated in FIGS. 8 and 9, the coil deformation process P3 is executed with the position adjuster 61 fixed in position in the axial direction L with respect to the coil holder 50. In the embodiment, the coupling portions 35c of the plurality of annular conductors 35 are deformed by moving the coil pusher 71 upward along the blades 51 (along the axial direction L) to a predetermined set position Ps with both the coil holder 50 and the position adjuster 61 fixed in absolute position. In the example, all the coupling portions 35c of the annular conductors 35 constituting the coil 3 for the three phases are deformed collectively for the three phases.

The predetermined set position Ps is set to a position at which at least the axial interval D1 between the position adjuster 61 and the coil pusher 71 is shorter than the overall length D2 of the annular conductors 35 along the axial direction L before deformation (see FIG. 7). Here, as illustrated in FIG. 8, the coil pusher 71 is formed to have the swelling portion 71b which swells from the body portion 71a toward the stator core 2 (toward the position adjuster 61) in the axial direction L. However, the axial interval D1 between the position adjuster 61 and the coil pusher 71 is prescribed with no consideration of the swelling portion 71b. That is, in the embodiment, the axial interval D1 described above is the length of the separation between the lower end portion of the position adjuster 61 and the upper end portion of the body portion 71a of the coil pusher 71 along the axial direction L.

Moving the coil pusher 71 to the set position Ps set as described above presses the coupling portions 35c of the annular conductors 35 between the lower end surface of the position adjuster 61 and the upper end surface of the body portion 71a of the coil pusher 71 to deform the coupling portions 35c. That is, the coil pusher 71 (to be more exact, the body portion 71a) sequentially pushes up the coupling portions 35c of the annular conductors 35, which are disposed on the side of the inner peripheral surface of the coil holder 50 (the blades 51), from the side of the lower end portions to deform the coupling portions 35c. As the coupling portions 35c are pushed up, the first portions 35a of the annular conductors 35 are also pushed up in the catching gaps 52. In the embodiment, in addition, the wedge pushers 82 are also moved together with the coil pusher 71 to push up the wedges 25 to predetermined positions below the lower end surface of the stator core 2.

The set position Ps described above may be set to a position at which the axial interval D1 between the position adjuster 61 and the coil pusher 71 is equal to or less than half or one-third, for example, of the overall length D2 of the annular conductors 35 along the axial direction L before deformation. In the embodiment, further, the set position Ps described above is set to a position at which the axial interval D1 between the position adjuster 61 and the coil pusher 71 matches the length (which is referred to as a “compressed length”) D3 of the first portions 35a or the second portions 35b along the axial direction L (see FIG. 9) with the plurality of linear conductors 34 arranged with no gap in the catching gaps 52. The coil pusher 71 pushes up the first portions 35a of the annular conductors 35 to a position in the axial direction L matching the position in the axial direction of the second portions 35b. Consequently, the coil pusher 71 deforms the coupling portions 35c, which connect between the first portions 35a and the second portions 35b, so as to make a region in the axial direction L occupied by the coupling portions 35c smaller. In this way, the shape of the coupling portions 35c of the annular conductors 35 may be caused to approximate the shape of the coil end portions 32 (the crossover portions 31) after being wound around the stator core 2. In FIG. 9, for the purpose of improving the viewability, the coupling portions 35c are drawn so as to partially hang down with respect to the upper end surface of the coil pusher 71.

In this event, in the embodiment, the coupling portions 35c of the annular conductors 35 are supported in abutment with the outer peripheral surface of the swelling portion 71b of the coil pusher 71, and deformed as described above with movement (deformation) toward the inner side in the radial direction R restrained by the outer peripheral surface serving as an abutment surface. That is, with the coil pusher 71 moved to the set position Ps, the coil pusher 71, the position adjuster 61, and the blades 51 cooperate with each other to function as a mold for compacting the coupling portions 35c. The coupling portions 35c are compacted by the upper end surface of the body portion 71a, the lower end surface of the position adjuster 61, the outer peripheral surface of the swelling portion 71b, and the inner peripheral surfaces of the blades 51 in an annular space defined by such surfaces. Consequently, the apparent volume of the coupling portions 35c may be reduced to enhance the spatial density of the coupling portions 35c. In particular, the coupling portions 35c are deformed such that their length in the axial direction L matches the compressed length D3 described above, which maximizes the spatial density of the coupling portions 35c. Further, in the stator 1 after being completed, the balance in size between the coil end portions 32 on both sides in the axial direction L may be optimized. Thus, the ratio of the outside diameter of the swelling portion 71b to the outside diameter of the body portion 71a is set in consideration of such factors. For example, the ratio described above is preferably set such that the volume of the annular space described above matches a volume corresponding to the intended size of the coil end portions 32. After the coupling portions 35c of the annular conductors 35 are deformed in this way, the coil insertion process P4 is executed.

The set position Ps described above is set to a position at which the axial interval D1 between the position adjuster 61 and the coil pusher 71 is shorter than the axial length D4 of the stator core 2. In the embodiment, the compressed length D3 of the first portions 35a or the second portions 35b is intrinsically set to be shorter than the axial length D4 of the stator core 2. Therefore, in the embodiment, the axial interval D1 between the position adjuster 61 and the coil pusher 71 is also shorter than the axial length D4 of the stator core 2.

3-4. Coil Insertion Process

In the coil insertion process P4, the first portions 35a and the second portions 35b of the annular conductors 35 are inserted into the slots 22. In the coil insertion process P4, as illustrated in FIGS. 10 to 12, the coil pusher 71 is moved further upward along the axial direction L to insert the first portions 35a and the second portions 35b into the slots 22. In the embodiment, in addition, the wedge pushers 82 are moved along the axial direction L in coordination with the coil pusher 71 to also insert the wedges 25 into the slots 22.

In the coil insertion process P4, the position adjuster 61 is moved in the axial direction L in accordance with (in coordination with) movement of the coil pusher 71 in the axial direction L. In the embodiment, the axial interval D1 between the position adjuster 61 and the coil pusher 71 is set so as to coincide with the compressed length D3 described above with the swelling portion 71h of the coil pusher 71 fitted with the position adjuster 61. In this state, the coil pusher 71 and the position adjuster 61 are moved in the axial direction L. Consequently, the axial interval D1 between the position adjuster 61 and the coil pusher 71 is maintained at the compressed length D3 described above. Moving the position adjuster 61 and the coil pusher 71 while keeping their relative positional relationship moves the coupling portions 35c, which have been deformed in the coil deformation process P3, in the axial direction L in the same state without further deforming the coupling portions 35c. Hence, it is possible to move the coupling portions 35c in the axial direction L while suppressing application of an unwanted stress to the coupling portions 35c to collapse the shape of the coupling portions 35c.

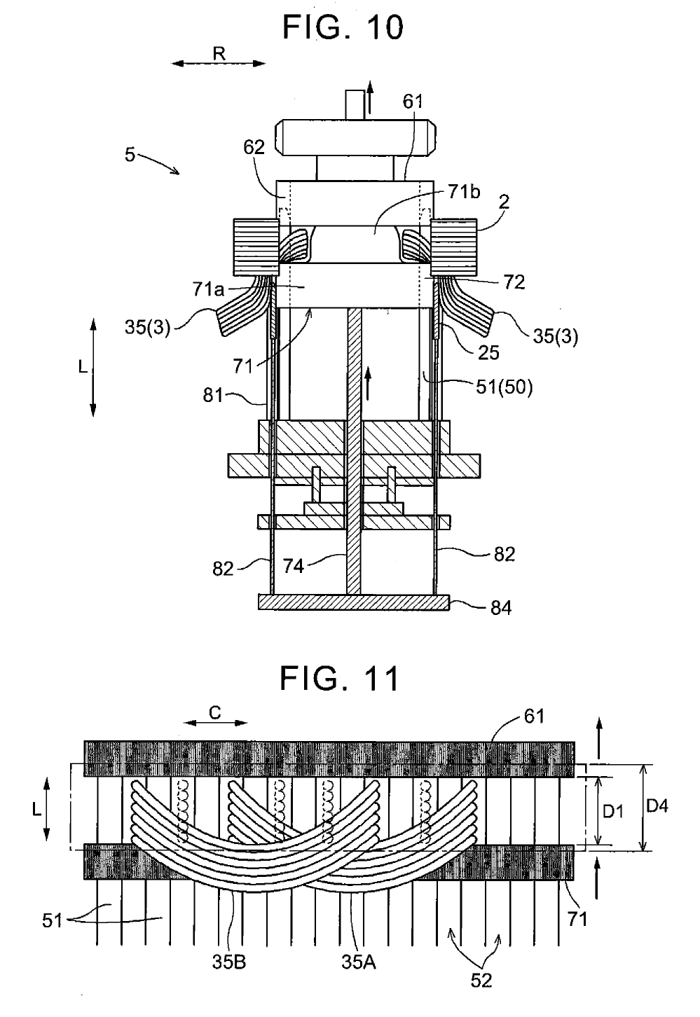

Here, FIGS. 10 and 11 illustrate one phase in a middle stage of the coil insertion process P4. In the embodiment, as described above, the axial interval D1 between the position adjuster 61 and the coil pusher 71 is shorter than the axial length D4 of the stator core 2. Therefore, as is understood from FIGS. 10 and 11, the coil insertion process P4 is executed by way of a state in which both the projecting teeth 62 of the position adjuster 61 and the pushing teeth 72 of the coil pusher 71 are disposed in the inner peripheral opening portions 22a of the slots 22 through the catching gaps 52. That is, the coil insertion process P4 is executed with at least the projecting teeth 62 of the position adjuster 61 or the pushing teeth 72 of the coil pusher 71 disposed in the inner peripheral opening portions 22a of the slots 22 through the catching gaps 52 through the entire process. Hence, the coil insertion process P4 may be executed while appropriately maintaining the relative positional relationship between the catching gaps 52 and the slots 22. This is particularly effective in the coil insertion device 5 according to the embodiment, in which the positions of the upper end portions of the blades 51 are not easily determined accurately as discussed above.

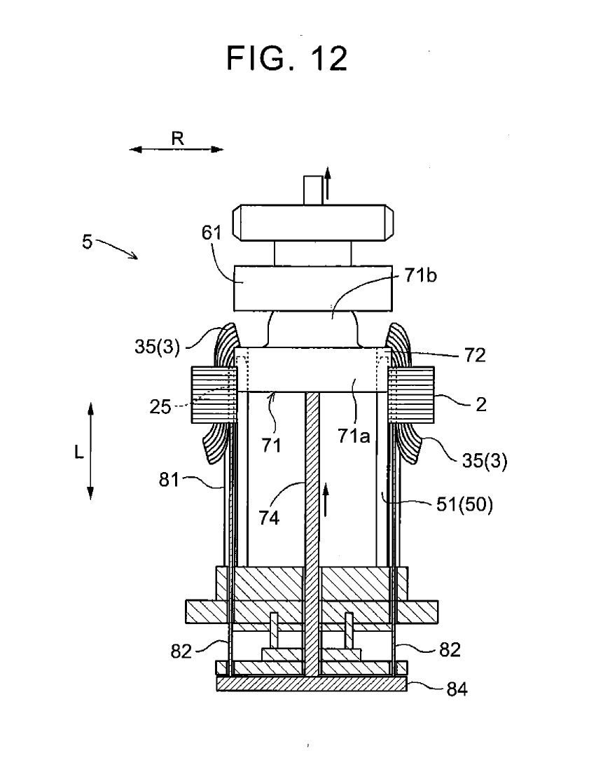

FIG. 12 illustrates the final phase of the coil insertion process P4. In the coil insertion process P4, as illustrated in the drawing, the coil pusher 71 is finally moved to a position at which its upper end surface is positioned further above the upper end surface of the stator core 2. In the example, the coil pusher 71 and the wedges 25 are moved to a position at which the upper end portions of the wedges 25 are aligned with the upper end surface of the stator core 2 in the axial direction L. Consequently, the coupling portions 35c of the plurality of annular conductors 35 after deformation are disposed at a position at which the coupling portions 35c project in the axial direction L from the stator core 2. In addition, the inner peripheral opening portions 22a of the slots 22 are blocked by the wedges 25, and the coil 3 after being inserted into the slots 22 is held by the wedges 25 from the inner side in the radial direction R. It should be noted, however, that in this stage, the coupling portions 35c are still partially disposed on the inner side in the radial direction R with respect to the blades 51. The plurality of coupling portions 35c are finally turned into the plurality of crossover portions 31 constituting the spiral coil end portions 32. In addition, as the coupling portions 35c are disposed at a position at which the coupling portions 35c project in the axial direction L from the stator core 2, the first portions 35a and the second portions 35b of the plurality of annular conductors 35 and surrounding portions are inserted into the slots 22.

Here, in the example, all the coupling portions 35c of the annular conductors 35 constituting the coil 3 for the three phases are disposed, collectively for the three phases, at a position at which the coupling portions 35c project in the axial direction L from the stator core 2, and all the first portions 35a and the second portions 35b and the surrounding portions are inserted into the slots 22 collectively for the three phases.

In the embodiment, the coupling portions 35c of the annular conductors 35 have already been deformed into a shape that is close to the shape of the coil end portions 32 after being wound around the stator core 2 in the coil deformation process P3. This facilitates insertion of the annular conductors 35 into the slots 22 in the subsequent coil insertion process P4. At this time, reducing the imbalance in size between the coil end portions 32 on both sides in the axial direction L to achieve appropriate balance effectively suppresses the annular conductors 35 being caught or the like, which facilitates insertion of the annular conductors 35 into the slots 22. The spatial density of the coupling portions 35c has been enhanced, which allows the coil end portions 32 to be reduced in size in the stator 1 completed finally compared to those according to the related art. The coil insertion process P4 may be executed while maintaining the relative positional relationship between the catching gaps 52 and the slots 22 appropriately, which allows the first portions 35a and the second portions 35b of the annular conductors 35 to be reliably inserted into the slots 22. The wedge pushers 82 are slid in coordination with the coil pusher 71, which facilitates insertion of the wedges 25 while the pushing teeth 72 are pushing the annular conductors 35 inward (toward the side opposite to the inner peripheral opening portions 22a; in the example, outward in the radial direction R) in the slots 22.

3-5. Coil Shaping Process

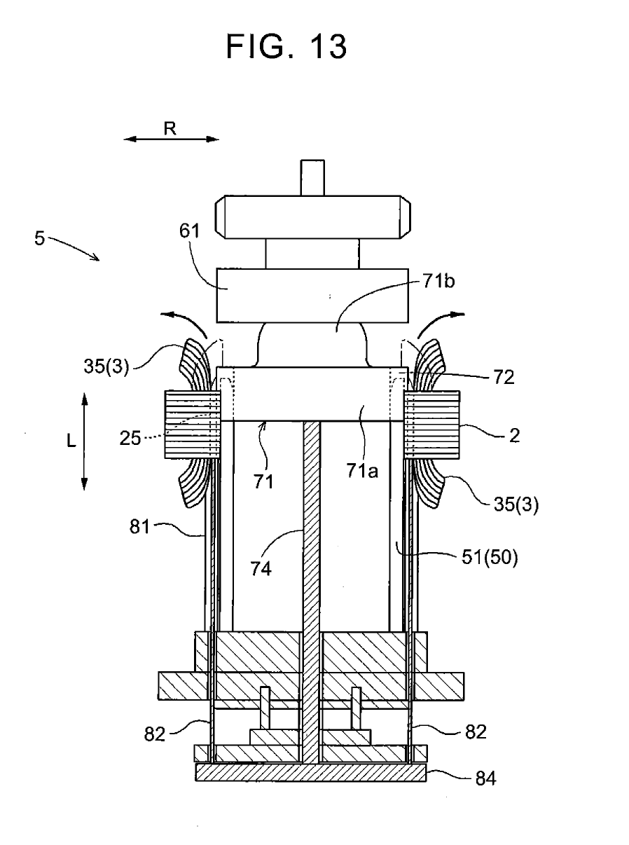

In the coil shaping process P5, the coupling portions 35c of the annular conductors 35 inserted into the slots 22 are shaped. In the coil shaping process P5, as illustrated in FIG. 13, the coupling portions 35c are deformed so as to be pushed outward in the radial direction R using a predetermined shaping jig (not illustrated). Consequently, the spiral coil end portions 32 illustrated in FIG. 1 are formed.

After that, the stator core 2 around which the coil 3 is wound is removed from the coil insertion device 5 to complete the stator 1 according to the embodiment. As has been described above, with the stator manufacturing method according to the embodiment, it is relatively easy to manufacture the stator 1 in a so-called spiral shape.

### 4. Other Embodiments

Lastly, stator manufacturing methods and stator manufacturing apparatuses according to other embodiments of the present invention will be described. A configuration disclosed in each of the following embodiments may be applied in combination with a configuration disclosed in any other embodiment unless any contradiction occurs.

(1) In the embodiment described above, in the coil arrangement process P2, the first portion 35a of each of the annular conductors 35 is inserted into one of the catching gaps 52, and the second portion 35b of the annular conductor 35 is inserted into a catching gap 52 that is away from the catching gap 52a by five pitches. Consequently, the stator 1 in which the coil 3 is wound around the stator core 2 such that two coils 3 for each phase repeatedly appear along the circumferential direction C is manufactured. However, embodiments of the present invention are not limited thereto. For example, the first portion 35a of each of the annular conductors 35 may be inserted into one of the catching gaps 52, and the second portion 35b of the annular conductor 35 may be inserted into a catching gap 52 that is away from the catching gap 52a by three pitches. In this case, the stator 1 in which the coil 3 is wound around the stator core 2 such that one coil 3 for each phase repeatedly appears along the circumferential direction C may be manufactured. Besides, the number of pitches between a set of catching gaps 52 into which the first portion 35a and the second portion 35b of each of the annular conductors 35 are inserted may be changed in accordance with the manner of winding of the coils 3 for each phase around the stator core 2.

(2) In the embodiment described above, the coil deformation process P3 is executed with both the coil holder 50 and the position adjuster 61 fixed in absolute position. However, embodiments of the present invention are not limited thereto. That is, the coil deformation process P3 may be executed with the coil holder 50 moving and with the position adjuster 61 correspondingly moving if at least the position adjuster 61 is fixed in relative position in the axial direction L with respect to the coil holder 50.

(3) In the embodiment described above, the axial interval D1 between the position adjuster 61 and the coil pusher 71 is set so as to match the compressed length D3 described above with the coil pusher 71 located at the set position Ps. However, embodiments of the present invention are not limited thereto. That is, the axial interval D1 between the position adjuster 61 and the coil pusher 71 may be set as desired as long as at least the axial interval D1 is set to be shorter than the overall length D2 of the annular conductors 35 along the axial direction L before deformation by the coil deformation process P3. For example, the axial interval D1 between the position adjuster 61 and the coil pusher 71 may be set to a length obtained by adding a predetermined margin to the compressed length D3 described above or the like.

(4) In the embodiment described above, the axial interval D1 between the position adjuster 61 and the coil pusher 71 is set to be shorter than the axial length D4 of the stator core 2 with the coil pusher 71 located at the set position Ps. However, embodiments of the present invention are not limited thereto. That is, the axial interval D1 between the position adjuster 61 and the coil pusher 71 may be set so as to match the axial length D4 of the stator core 2, or to be longer than the axial length D4 of the stator core 2.

(5) In the embodiment described above, the compressed length D3 of the first portions 35a and the second portions 35b of the annular conductors 35 is set to be shorter than the axial length D4 of the stator core 2, and accordingly the axial interval D1 between the position adjuster 61 and the coil pusher 71 is also set to be shorter than the axial length D4 of the stator core 2. In some cases, however, the compressed length D3 described above determined initially may be longer than the axial length D4 of the stator core 2. In such cases, the procedure may return to the coil preparation process P1, where the number of times that the linear conductors 34 are circulated may be reduced to make the compressed length D3 described above shorter than the axial length D4 of the stator core 2. For example, defining N as a natural number of two or more, the number of times that the linear conductors 34 are circulated may be determined as 1/N. In this case, N sets of coils 3 formed as in the embodiment described above are preferably wound around the stator core 2. In this case, in the coil preparation process P1, a number of annular conductors 35 are prepared, the number being N/2 times the number of the slots 22 of the stator core 2. Then, the coil arrangement process P2, the coil deformation process P3, the coil insertion process P4, and the coil shaping process P5 are executed on a number of sets of annular conductors 35, the number being half the number of the slots 22 of the stator core 2, and the processes are repeated N times. N sets of first portions 35a, second portions 35b, and surrounding portions are inserted into each of the slots 22. In this case, in the coil insertion device 5, the coil pusher 71 and the wedge pushers 82 are configured to be independently slidable. In the coil insertion process P4 for the first to (N−1)-th sets of annular conductors 35, only the coil pusher 71 is slid to insert only the annular conductors 35. In the coil insertion process P4 for the last, N-th set of annular conductors 35, the coil pusher 71 and the wedge pushers 82 are slid in coordination with each other to also insert the wedges 25.

(6) In the embodiment described above, the axial interval D1 between the position adjuster 61 and the coil pusher 71 is maintained in the coil insertion process P4. However, embodiments of the present invention are not limited thereto. That is, the axial interval D1 between the position adjuster 61 and the coil pusher 71 may be reduced by moving the position adjuster 61 in the axial direction L at a movement speed that is lower than the movement speed of the coil pusher 71 in the axial direction L, for example. Alternatively, the axial interval D1 between the position adjuster 61 and the coil pusher 71 may be increased by moving the position adjuster 61 in the axial direction L at a movement speed that is higher than the movement speed of the coil pusher 71 in the axial direction L, for example. The coil insertion process P4 may be executed with the position adjuster 61 moved prior to the coil pusher 71 to be disposed at the initial position for the coil arrangement process P2 (a position further above the upper end portions of the blades 51).

(7) In the embodiment described above, the wedges 25 are inserted at the same time as the first portions 35a and the second portions 35b of the annular conductors 35 are inserted into the slots 22 in the coil insertion process P4. However, embodiments of the present invention are not limited thereto. That is, the wedges 25 may be inserted in a process (a wedge insertion process) that is different from the coil insertion process P4. Such a wedge insertion process may be executed between the coil insertion process P4 and the coil shaping process P5, after the coil shaping process P5, or the like, for example. Such configurations may be achieved by configuring the coil pusher 71 and the wedge pushers 82 to be independently slidable in the coil insertion device 5.

(8) In the embodiment described above, the coil preparation process P1 and the subsequent processes P2 to P5 are executed consecutively at the same location. However, embodiments of the present invention are not limited thereto. That is, the coil preparation process P1 may be executed at a temporally and/or geographically different location, and the subsequent processes P2 to P5 may be executed using the separately formed annular conductors 35.

(9) In the embodiment described above, a winding device and a coil arranging device that are separate from the stator manufacturing apparatus 100 (the coil insertion device 5) are used. The coil preparation process P1 is executed using the winding device, the coil arrangement process P2 is executed using the coil arranging device, and the coil deformation process P3, the coil insertion process P4, and the coil shaping process P5 are executed using the stator manufacturing apparatus 100. However, embodiments of the present invention are not limited thereto. That is, the stator manufacturing apparatus 100 may be provided with the function of at least one of the winding device and the coil arranging device, for example. In this case, the control section 90 controls at least one of the coil preparation process P1 and the coil arrangement process P2 in addition to the processes P3 to P5.

(10) In the embodiment described above, the stator 1 in which the coil 3 is wound around the stator core 2 by lap winding and distributed winding is manufactured. However, application of the present invention is not limited thereto. For example, the present invention may be applied to the manufacture of a stator 1 in which the coil 3 is wound around the stator core 2 by wave winding in place of lap winding, or a stator 1 in which the coil 3 is wound around the stator core 2 by concentrated winding in place of distributed winding.

(11) In the embodiment described above, the stator 1 for a rotary electric machine of an inner rotor type is manufactured. However, application of the present invention is not limited thereto. That is, the present invention may be applied to the manufacture of a stator 1 for a rotary electric machine of an outer rotor type.

(12) Also regarding other configurations, the embodiment disclosed herein is illustrative in all respects, and the present invention is not limited thereto. That is, a configuration not described in the claims of the present invention may be altered without departing from the object of the present invention.

### INDUSTRIAL APPLICABILITY

The present invention may be suitably applied to a stator manufacturing method and a stator manufacturing apparatus for manufacturing a stator by winding a coil around a stator core.

### DESCRIPTION OF THE REFERENCE NUMERALS

1 STATOR
2 STATOR CORE
3 COIL
5 COIL INSERTION DEVICE
22 SLOT
23 TOOTH
31 CROSSOVER PORTION
32 COIL END PORTION
34 LINEAR CONDUCTOR
35 ANNULAR CONDUCTOR
35a FIRST PORTION
35b SECOND PORTION
35c COUPLING PORTION
50 COIL HOLDER
51 BLADE
52 CATCHING GAP
52a FIRST CATCHING GAP
52a′ FIRST CATCHING GAP
52b SECOND CATCHING GAP
52b′ SECOND CATCHING GAP
61 POSITION ADJUSTER
71 COIL PUSHER
71a BODY PORTION
71b SWELLING PORTION
90 CONTROL SECTION
100 COIL MANUFACTURING DEVICE
C CIRCUMFERENTIAL DIRECTION
L AXIAL DIRECTION
R RADIAL DIRECTION
X AXIS
S SPIRAL LINE
Ps SET POSITION
D1 AXIAL INTERVAL BETWEEN COIL PUSHER AND POSITION ADJUSTER
D2 OVERALL LENGTH OF ANNULAR CONDUCTOR ALONG AXIAL DIRECTION BEFORE DEFORMATION
D3 COMPRESSED LENGTH OF ANNULAR CONDUCTOR
D4 AXIAL LENGTH OF STATOR CORE
P2 COIL ARRANGEMENT PROCESS
P3 COIL DEFORMATION PROCESS
P4 COIL INSERTION PROCESS

1-10. (canceled)

11. A stator manufacturing method for manufacturing a stator by winding a coil around a stator core using a coil insertion device, wherein:
a coil end portion of the coil that projects in an axial direction of the stator core from the stator core includes a plurality of crossover portions that extend in a circumferential direction of the stator core to connect between different slots of the stator core;
each of the crossover portions is disposed such that one end portion of the crossover portion in the circumferential direction is positioned radially inwardly of the other crossover portions located at the same circumferential position, and such that the other end portion of the crossover portion in the circumferential direction is positioned radially outwardly of the other crossover portions located at the same circumferential position; and
the coil insertion device includes a coil holder having a plurality of blades extending in the axial direction and arranged along the circumferential direction so as to face a plurality of teeth of the stator core, a position adjuster fitted with the plurality of blades to adjust a positional relationship between the blades, and a coil pusher that pushes the coil held by the coil holder toward the slots of the stator core,
the stator manufacturing method comprising:
a coil arrangement process in which a plurality of annular conductors constituting the coil are disposed in the coil holder such that a first portion of each of the annular conductors is inserted into a first catching gap formed between the blades, a second portion of each of the annular conductors is inserted into a second catching gap that is away from the first catching gap by a predetermined pitch, and a coupling portion, which connects between the first portion and the second portion of each of the plurality of annular conductors, passes through one side, in the axial direction, of the first portions of the other annular conductors disposed at positions overlapping the coupling portion as viewed in the axial direction;
a coil deformation process which is performed after the coil arrangement process and in which the coupling portion of each of the plurality of annular conductors is deformed by moving the coil pusher in the axial direction along the blades to a set position at which an axial interval between the position adjuster and the coil pusher is shorter than an overall length of the annular conductors along the axial direction before deformation with the position adjuster fixed in position with respect to the coil holder; and
a coil insertion process which is performed after the coil deformation process and in which the first portion and the second portion of each of the annular conductors are inserted into the slots by further moving the coil pusher in the axial direction.

12. The stator manufacturing method according to claim 11, wherein
in the coil insertion process, the position adjuster is moved in the axial direction in accordance with axial movement of the coil pusher while maintaining the axial interval between the position adjuster and the coil pusher.

13. The stator manufacturing method according to claim 11, wherein
in the coil deformation process, the axial interval between the position adjuster and the coil pusher is set to be shorter than an axial length of the stator core with the coil pusher located at the set position.

14. The stator manufacturing method according to claim 11, wherein:
the annular conductors are constituted from a bundle of a plurality of linear conductors; and
in the coil deformation process, the axial interval between the position adjuster and the coil pusher with the coil pusher located at the set position is set such that the axial interval matches a length of the first portions or the second portions along the axial direction with the plurality of linear conductors arranged with no gap in the catching gaps.

15. The stator manufacturing method according to claim 11, wherein:
the coil pusher has a body portion in a shape of a disc formed along the plurality of blades, and a swelling portion that swells toward the position adjuster from the body portion in the axial direction, the swelling portion being foamed to be smaller in diameter than the body portion; and
in the coil deformation process, the annular conductors are supported in abutment with an outer peripheral surface of the swelling portion, and the coupling portions of the annular conductors are deformed with movement of the annular conductors toward a radially inner side restrained.

16. The stator manufacturing method according to claim 12, wherein
in the coil deformation process, the axial interval between the position adjuster and the coil pusher is set to be shorter than an axial length of the stator core with the coil pusher located at the set position.

17. The stator manufacturing method according to claim 16, wherein:
the annular conductors are constituted from a bundle of a plurality of linear conductors; and
in the coil deformation process, the axial interval between the position adjuster and the coil pusher with the coil pusher located at the set position is set such that the axial interval matches a length of the first portions or the second portions along the axial direction with the plurality of linear conductors arranged with no gap in the catching gaps.

18. The stator manufacturing method according to claim 17, wherein:
the coil pusher has a body portion in a shape of a disc formed along the plurality of blades, and a swelling portion that swells toward the position adjuster from the body portion in the axial direction, the swelling portion being formed to be smaller in diameter than the body portion; and
in the coil deformation process, the annular conductors are supported in abutment with an outer peripheral surface of the swelling portion, and the coupling portions of the annular conductors are deformed with movement of the annular conductors toward a radially inner side restrained.

19. A stator manufacturing apparatus for manufacturing a stator by winding a coil around a stator core, comprising:
a coil holder having a plurality of blades extending in an axial direction and arranged along a circumferential direction so as to face a plurality of teeth of the stator core;
a position adjuster fitted with the plurality of blades to adjust a positional relationship between the blades;
a coil pusher that pushes the coil held by the coil holder toward slots of the stator core; and
a control section that controls operation of at least the position adjuster and the coil pusher, wherein
with a plurality of annular conductors constituting the coil disposed such that a first portion of each of the annular conductors is inserted into a first catching gap formed between the blades, a second portion of each of the annular conductors is inserted into a second catching gap that is away from the first catching gap by a predetermined pitch, and a coupling portion, which connects between the first portion and the second portion of each of the plurality of annular conductors, passes through one side, in the axial direction, of the first portions of the other annular conductors disposed at positions overlapping the coupling portion as viewed in the axial direction,
the control section executes:
a coil deformation process in which the coupling portion of each of the plurality of annular conductors is deformed by moving the coil pusher in the axial direction along the blades to a set position at which an axial interval between the position adjuster and the coil pusher is shorter than an overall length of the annular conductors along the axial direction before deformation with the position adjuster fixed in position with respect to the coil holder; and
a coil insertion process in which the first portion and the second portion of each of the annular conductors are inserted into the slots by further moving the coil pusher in the axial direction, the coil insertion process being executed after the coil deformation process.

20. The stator manufacturing apparatus according to claim 19, wherein
in the coil insertion process, the control section causes the position adjuster to be moved in the axial direction in accordance with axial movement of the coil pusher while maintaining the axial interval between the position adjuster and the coil pusher.

21. The stator manufacturing apparatus according to claim 19, wherein
in the coil deformation process, the control section sets the axial interval between the position adjuster and the coil pusher to be shorter than an axial length of the stator core with the coil pusher located at the set position.

22. The stator manufacturing apparatus according to claim 19, wherein:
the annular conductors are constituted from a bundle of a plurality of linear conductors; and
in the coil deformation process, the control section sets the axial interval between the position adjuster and the coil pusher with the coil pusher located at the set position such that the axial interval matches a length of the first portions or the second portions along the axial direction with the plurality of linear conductors arranged with no gap in the catching gaps.

23. The stator manufacturing apparatus according to claim 19, wherein:
the coil pusher has a body portion in a shape of a disc formed along the plurality of blades, and a swelling portion that swells toward the position adjuster from the body portion in the axial direction, the swelling portion being formed to be smaller in diameter than the body portion; and
in the coil deformation process, the control section causes the annular conductors to be supported in abutment with an outer peripheral surface of the swelling portion, and causes the coupling portions of the annular conductors to be deformed with movement of the annular conductors toward a radially inner side restrained.

24. The stator manufacturing apparatus according to claim 20, wherein
in the coil deformation process, the control section sets the axial interval between the position adjuster and the coil pusher to be shorter than an axial length of the stator core with the coil pusher located at the set position.

25. The stator manufacturing apparatus according to claim 24, wherein:
the annular conductors are constituted from a bundle of a plurality of linear conductors; and
in the coil deformation process, the control section sets the axial interval between the position adjuster and the coil pusher with the coil pusher located at the set position such that the axial interval matches a length of the first portions or the second portions along the axial direction with the plurality of linear conductors arranged with no gap in the catching gaps.

26. The stator manufacturing apparatus according to claim 25, wherein:
the coil pusher has a body portion in a shape of a disc formed along the plurality of blades, and a swelling portion that swells toward the position adjuster from the body portion in the axial direction, the swelling portion being formed to be smaller in diameter than the body portion; and
in the coil deformation process, the control section causes the annular conductors to be supported in abutment with an outer peripheral surface of the swelling portion, and causes the coupling portions of the annular conductors to be deformed with movement of the annular conductors toward a radially inner side restrained.
